(19) United States
(12) Patent Application Publication
(10) Pub. No.: US 2008/0168712 A1
(43) Pub. Date: Jul. 17, 2008

(54) Modified Pet Flap Arrangements

(76) Inventor: Peter McDermott, Hertfordshire (GB)

Correspondence Address: FAY SHARPE LLP, 1100 SUPERIOR AVENUE, SEVENTH FLOOR, CLEVELAND, OH, 44114, US

(21) Appl. No.: 11/886,080

(22) PCT Filed: Dec. 14, 2005
(86) PCT No.: PCT/GB2005/004826

§ 371 Date: Mar. 11, 2008

(30) Foreign Application Priority Data
Dec. 14, 2004 (GB) 0427317.3

(51) Int. Cl. E06B 7/32

(52) U.S. Cl. 49/169

(57) ABSTRACT

A pet flap arrangement in which an outermost section including an outer periphery of the arrangement at least partly surrounds a flap component. The section has an external appearance resembling a door or door entrance.

This invention is concerned with pet flap arrangements which in one aspect provides an accessory to fit existing door-mounted pet flaps and in another aspect provides arrangements wherein part of the pet flap structure is modified prior to fitment.

Pet flaps are well known devices which provide a convenient entrance and exit for mainly domestic pets through a door, in which a hinged flap covers an aperture in a door enabling pets to enter or leave a dwelling unaided and without recourse to manual opening of the door.

Known pet flaps typically comprise component parts which form a framework surrounding an aperture in the door, wherein parts of the frame forming the pet flap arrangement protrude above the surfaces of the door, and in which a hinged flap may be opened by the pet to close when the pet has entered or left the dwelling.

Typically the pet flap framework has a rather conventional and only functional plain appearance. The protruding frame portions of the framework may represent a point of weakness in the structure. The security of the dwelling may be compromised by the aperture and the external periphery of the framework in existing pet flap arrangements may provide readily visible means for tampering with the arrangement for unauthorised access. Thus the close proximity in conventional pet flap arrangements of the external periphery of the framework to the aperture in the door can be a disadvantage.

The present invention seeks to provide a modified pet flap arrangement which has an attractive appearance and which can enhance the security to the dwelling which may be compromised as aforesaid.

Accordingly the present invention provides a pet flap arrangement in which an outermost section including the outer periphery of the arrangement at least partly surrounds the flap component and said section has an external appearance in the style of a door or door entrance.

In some preferred embodiments the outermost section may be integrally formed with a frame section of the arrangement incorporating the flap. In other preferred embodiments the said outermost section may be constructed as a removable surround adapted to fit around the periphery of a projecting frame component in which the flap is mounted. Such embodiments can be fashioned as an ‘after market’ accessory to fit a wide variety of and possibly all known versions of existing pet flap arrangements.

The door style or entrance for the said outermost section can be selected from amongst a wide variety. For example, the style may be selected from amongst the preferred possibilities of architectural, grand entrance, barn, church, chigwell style, gothic style amongst many possibilities

The outermost section may incorporate the appearance of stonework, woodwork or metal work. For instance, architectural style may include surface components fashioned as columns with or without facades. An architectural style door surround, as such an outermost section, may give the appearance of a grand entrance. Traditional door styles may be fashioned by including panels and/or beams in the external surface appearance. Additionally, the outermost section may include features resembling hinges, bolts, locks and handles.

In some embodiments, the outermost section need not fully and completely surround the pet flap framework but may substantially surround it such as by extending around at least three sides of a total of four sides.

The outermost surround may be fabricated from amongst a variety of suitable materials. For instance, the surround may be constructed from wood, fibreboard, plastics which may be coloured or left white to be decorated as required as by the installer. The arrangements may be provided with a decorating kit such as a painting or varnishing kit to enable a match to be made with existing woodwork or other decor. Such a kit may comprise installation and decoration instructions. The decoration instructions may include a colour chart or suggested colour scheme especially when the door style includes hinges, bolts and the like.

In order that the invention may be illustrated, more easily appreciated and readily carried into effect by those skilled in the art embodiments thereof will now be described by way of non-limiting example only with reference to the accompanying drawings and in which:

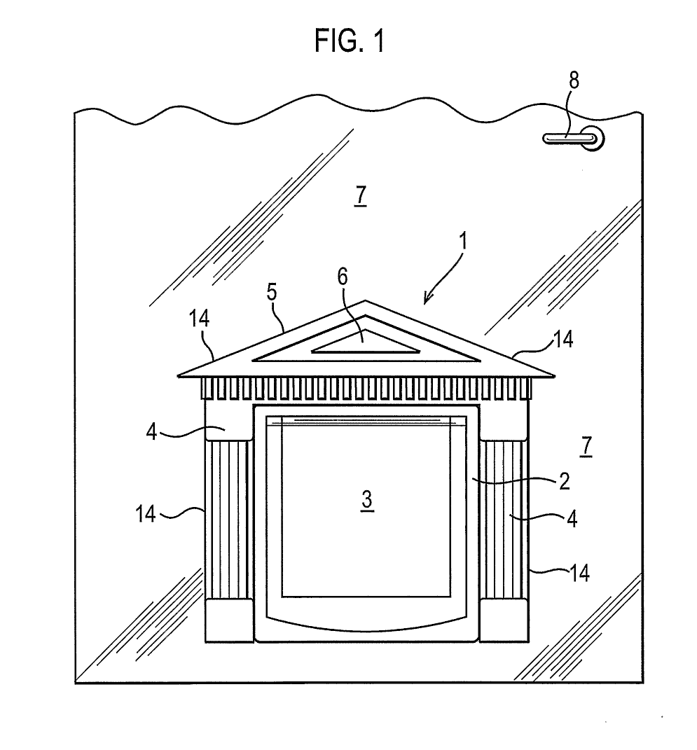

FIG. 1 is a schematic illustration of a removable surround for modifying an existing pre-fitted cat flap arrangement,

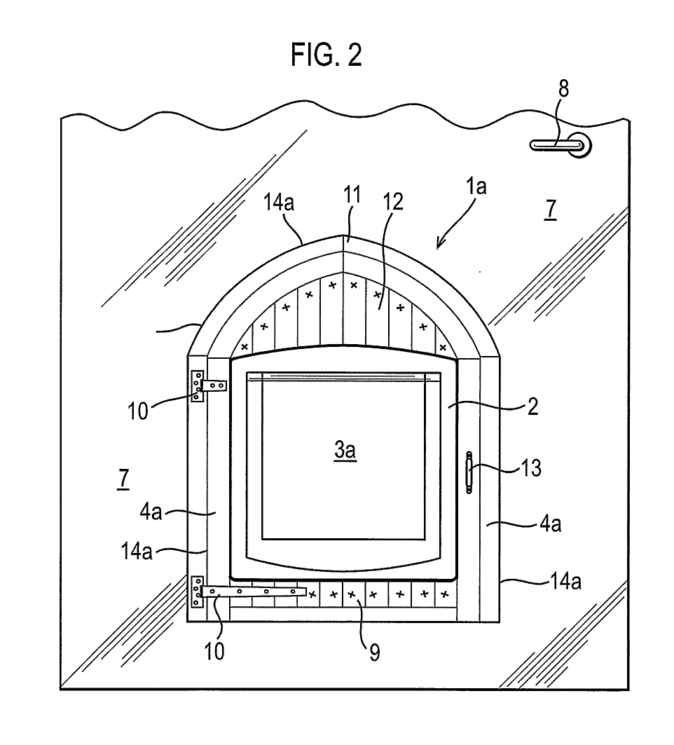

FIG. 2 is a similar schematic view of a surround incorporating the external appearance of a different door style to the architectural ‘grand entrance’ style shown in FIG. 1, and

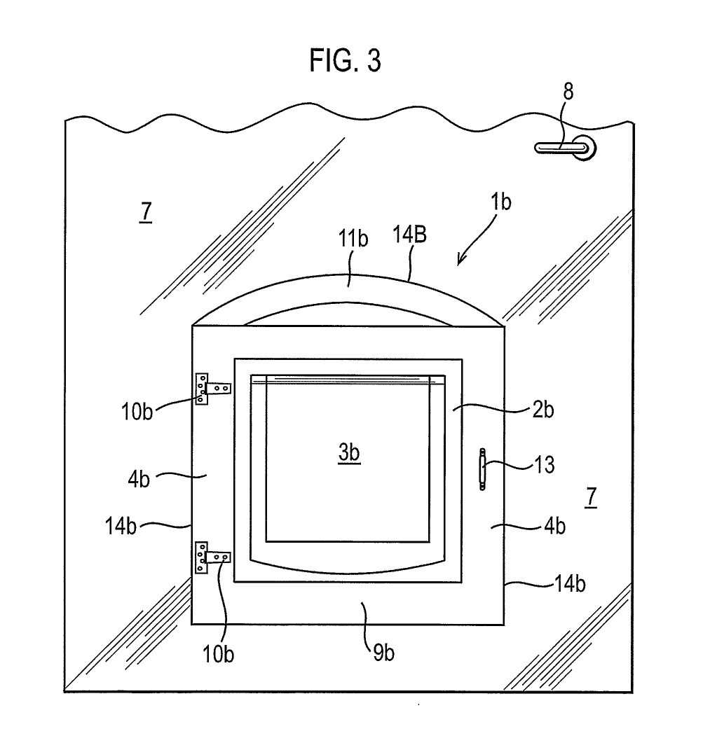

FIG. 3 is a schematic illustration of a pet flap arrangement modified by the integral formation of a door surround forming a one-piece surround incorporating the pet flap.

Referring to the drawings and firstly to FIG. 1 thereof, the pet flap arrangement 1 is fashioned as a removable surround to fit over the external protruding rim of an existing framework 2 incorporating the movable flap 3. The outermost section comprising the modification includes a pair of spaced apart generally upright columns 4 connected to an upper or roof section 5 incorporating a decorative facade 6. The external periphery of the outermost section is referenced 14 and it is possible to provide an enhanced or permanent connection by passing securing means (not shown) through the outer periphery 14 of the outermost surround and into the periphery of the enclosed framework 2. Alternative means of securement are envisaged. The outermost surround could be adhered to the adjacent door panel by means of a suitable adhesive. The existing pet flap 2,3 is already provided within a door 7 of a domestic dwelling opened by handle 8. In the arrangement depicted in FIG. 1, the outermost surround is fashioned in the form of an architectural surround which mimics the appearance of a miniature grand entrance for the pet. To the pet, such an arrangement may provide a ‘front door’ which is of realistic and simultaneously attractive appearance.

The illustrated surround for an existing pet flap may be, for example, in the ‘chigwell style’ or alternatively it could be fashioned as ‘georgian’ or ‘mock tudor.’ The outermost surround could be constructed from fibreboard such as medium density fibreboard (MDF) or alternatively it could be constructed from moulded plastics material or from MDF which is coloured. Alternatively the base component may be provided in white and the outermost surround may be provided with a painting kit so that purchasers can match their existing décor of the main door in which the pet flap has been located. In a kit comprising the outermost surround instructions may be provided showing how to fit and decorate the removable surround coupled with a colour chart or other suggested colour scheme. Referring to FIG. 2 a similar arrangement is shown and in which similar structural components have been allocated corresponding reference numerals as previously described. Thus in this arrangement of outermost surround, the door style maybe for example in a ‘gothic style’ and in which the arrangement 1a incorporates the existing framework 2 and pet flap 3a, being bounded by a pair of generally upright members 4a integrally formed with an underneath part 9 and uppermost part 11. The door style may include wood panelling effects at the facade 12 which may extend into and around the underneath part 9. Decorative hinges 10 are included on the outer uppermost surface of the section 1a. This outermost section may for example be constructed of oak although alternatively it could be made from moulded plastic material or from MDF which is coloured or possibly white. In the case of materials provided in white or other natural colour, a painting kit maybe provided so that purchasers can decorate the outermost section of the arrangement to match the existing decor of the door 7 in which the flap 3a is mounted. Again in similar fashion to the embodiment depicted in FIG. 1, the outermost section maybe supplied as an ‘after market’ accessory in kit form including an insert with instructions on how to secure the outermost section to the framework 2 of the pet flap together with a suggested colour chart and/or colour scheme and possibly incorporating paints such as black paint for the intended bolts, hinges and handle of the particular door style.

An alternative arrangement 1b of pet flap is provided and illustrated in FIG. 3. In this arrangement the door style is provided integrally as a one piece construction in conjunction with the pet flap framework 2b,3b. In appearance, the door style may resemble the embodiments earlier described with reference to FIGS. 1 and 2, however this embodiment differs in that the modified pet flap arrangement includes the door style at the time of construction and sale i.e. before the fitting of a pet flap to any door. In general like references have been used to describe like components described previously with reference to FIGS. 1 and 2. Any slight differences in the construction or arrangement have been signified with a suffix letter ‘b.’ Thus the overall arrangement 1b includes the pet flap framework 2b and pet flap 3b and the door style outermost surround is not separable therefrom as in the previously described embodiments. A pair of generally upright members 4b extend from opposite ends of member 9b and are integrally formed with an upper member 11b. The outermost surround may be, for example, constructed of oak and MDF although larger scale manufacture may suggest the use of moulded plastic materials or MDF which is coloured or white. As in previous embodiments, the pet flap arrangement may be provided with a painting kit so that purchasers and installers can match the existing decor of the main door in which the flap is to be located.

In all arrangements it will be appreciated that the effective external periphery of the conventional pet flap frame has been extended significantly beyond its former boundary. When the surround is securely affixed to the door and/or the flap frame the security into the dwelling is enhanced at the same time as the appearance of the pet flap is dramatically improved.

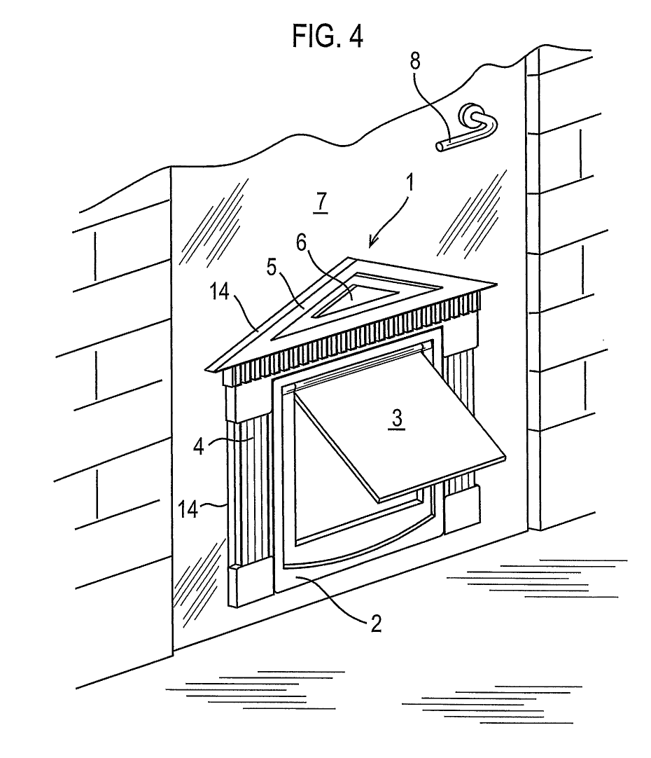

FIG. 4 corresponds generally with the FIG. 1 arrangement, but from a different perspective and with the pet flap opened. The reference numerals correspond.

1. A pet flap arrangement in which an outermost section including the outer periphery of the arrangement at least partly surrounds a flap component and said section has an external appearance resembling a door or door entrance.

2. An arrangement as claimed in claim 1, in which the outermost section is integrally formed with a frame section of the arrangement incorporating the flap, optionally as a one piece construction.

3. An arrangement as claimed in claim 1, in which the outermost section is constructed as a removable surround adapted to fit around the periphery of a projecting frame component in which the flap is mounted.

4. An arrangement as claimed in claim 1, which is constructed as an accessory able to fit a wide variety of known versions of pet flap constructions.

5. A pet flap arrangement as claimed in claim 1 in which the door style or entrance of the outermost section is selected from amongst the following: architectural, grand entrance, barn, church, Chigwell style, gothic style, Georgian and mock Tudor.

6. An arrangement as claimed in claim 1, in which the outermost section incorporates an appearance of stonework and/or woodwork and/or metalwork, optionally including features resembling hinges and/or bolts and/or locks and/or latches and/or handles.

7. An arrangement as claimed in claim 5, in which surface components of the outermost section are in the form of columns with or without facades, and/or panels and/or beams.

8. An arrangement as claimed in claim 1, in which the outermost section only partially surrounds the pet flap framework.

9. An arrangement as claimed in claim 8, in which the pet flap framework has four sides, around three of which the said outermost section extends.

10. An arrangement as claimed in claim 1 in which the outermost section is fabricated from at least one of the following materials, namely: wood, fibreboard and plastics.

11. A kit of parts for constructing and decorating a pet flap arrangement, which comprises an arrangement as defined in claim 1 in combination with painting and/or varnishing materials and optionally printed instructions for assembly and decoration.

12. A kit of parts as claimed in claim 11, wherein the outermost section provides a door style including the appearance of hinges and/or bolts and/or latches and/or locks and/or handles, and wherein decoration instructions are included with a colour chart and/or suggested colour scheme.

13. An arrangement as claimed in claim 1 in combination with securing means capable of passing through the outer periphery of the outermost section and into the periphery of the pet flap framework, and/or in combination with adhesive means whereby the outermost section can be adhered to an adjacent door panel and/or said framework.

14. (canceled)

15. A kit as claimed in claim 11 in combination with securing means capable of passing through the outer periphery of the outermost section and into the periphery of the pet flap framework, and/or in combination with adhesive means whereby the outermost section can be adhered to an adjacent door panel and/or said framework.
